(19) United States
(12) Patent Application Publication
(10) Pub. No.: US 2026/0136205 A1
(43) Pub. Date: May 14, 2026

(54) Interference Mitigation Between Terrestrial and Satellite Radio Networks Sharing Frequency

(71) Applicant: DISH Wireless L.L.C., Englewood, CO (US)

(72) Inventors: Premchand CHANDRAN, Brambleton, VA (US); Dilip TANDEKAR, Herndon, VA (US); Gurpreet SOHI, Parker, CO (US)

(73) Assignee: DISH Wireless L.L.C., Englewood, CO (US)

(21) Appl. No.: 18/946,317

(22) Filed: Nov. 13, 2024

(51) Int. Cl. H04W 16/14; H04L 5/00; H04W 48/16; H04W 84/06

(52) U.S. Cl. CPC H04W 16/14; H04L 5/0062; H04W 48/16; H04W 84/06

(57) ABSTRACT

A method and system for detecting and mitigating interference of a satellite signal by one or more cell signals includes receiving cell information from pods in an exclusion zone, which includes interference levels, Physical Cell Identity (PCI), and Reference Signal Receive Power (RSRP). The method monitors interference levels and RSRP, determines a Physical Resource Block (PRB) blanking level based on these metrics, and applies PRB blanking accordingly. The system comprises processors and a storage medium with programming instructions to execute these operations. The exclusion zone may be created for a National Oceanic and Atmospheric Administration (NOAA) earth station for an exclusion time period, and the method can involve AI/ML modules for inferring threshold levels.

### FIELD

The present teachings pertain to reduce interference between satellite and mobile communication systems, particularly through the use of artificial intelligence and machine learning to analyze data and strategically use blanking for reduced interference.

### BACKGROUND

In the realm of wireless communication, managing interference is a critical challenge, especially as the demand for spectrum resources continues to grow. For example, the n70 band is a specific frequency range used in telecommunications and in some satellite communications. Interference can lead to degraded communication quality, increased error rates, and reduced overall network performance. Traditionally, methods to mitigate this interference have relied on static approaches, such as predefined exclusion zones and manual adjustments, which can be inefficient and may not adapt well to dynamic changes in the environment. Exclusion zones and time periods are received from a satellite user and are typically based on a prediction model. The exclusion zone typically provides a list of sectors/cells or area barred from using the shared spectrum. The barring may be implemented using Full or Partial Blanking or the like. There is a need to lessen the impact on the terrestrial RAN by blanking only terrestrial cells causing the interference.

The need for more adaptive and intelligent interference management solutions has become apparent as networks evolve to support more users and higher data rates. The integration of AI and ML technologies into network management systems offers a promising avenue for addressing these challenges. By leveraging real-time data and advanced algorithms, AI and ML can provide more precise and timely adjustments to network parameters, potentially improving the efficiency and effectiveness of interference management. This approach not only aims to enhance the quality of service for end-users but also optimizes the use of available spectrum resources, which is crucial in today's increasingly connected world.

In the present teachings, the dependency on prediction model data from the satellite user (NOAA) is lessened or removed in the present teachings by detecting, rather than predicting, the interference impacted sectors over the shared frequency spectrum.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

In accordance with embodiments, a method is provided for detecting and mitigating interference of a satellite signal by one or more cell signals. The method involves receiving cell information from pods located in an exclusion zone, where the cell information includes an interference level experienced by a cell signal sharing a frequency spectrum with a satellite signal, a Physical Cell Identity (PCI) of the cell signal, and a Reference Signal Receive Power (RSRP) of the cell signal at a respective pod. The interference level and the RSRP are monitored, and a Physical Resource Block (PRB) blanking level is determined for each cell information received based on the interference level and the RSRP. A PRB of the PCI is blanked according to the PRB blanking level, which indicates at least one of a complete blanking, a partial blanking, or no blanking.

In accordance with other embodiments, the method includes receiving feeds from the pods, where each feed comprises current cell information detected by one of the pods. The exclusion zone may be created for a National Oceanic and Atmospheric Administration (NOAA) earth station for an exclusion time period. The method includes decoding the cell signal to obtain the cell information.

In further embodiments, the method involves associating, based on a location of a respective pod detecting the cell signal, a threshold RSRP and a threshold interference level for a respective PCI in the cell information. The threshold RSRP is compared to the RSRP of the respective PCI, and the threshold interference level is compared to the interference level of the respective PCI.

In yet other embodiments, the method involves associating, based on a location of a satellite communicating via the satellite signal, a threshold RSRP and a threshold interference level for a respective PCI in the cell information. The threshold RSRP is compared to the RSRP of the respective PCI, and the threshold interference level is compared to the interference level of the respective PCI.

In accordance with additional embodiments, the method includes inferring with an Artificial Intelligence/Machine Learning (AI/ML) module, based on a location of a satellite communicating via the satellite signal, a threshold RSRP and a threshold interference level for a respective PCI in the cell information. The threshold RSRP is compared to the RSRP of the respective PCI, and the threshold interference level is compared to the interference level of the respective PCI.

In further embodiments, the method includes recording, post-processing, and updating the AI/ML module using adaptive algorithms and decision-making models. The AI/ML module is trained to infer the threshold RSRP and the threshold interference level using a dataset, which includes records of a location from which the satellite signal is transmitted, a location of a pod in an exclusion zone, and cell information for the cell signal at the location.

In accordance with other embodiments, the PRB blanking level indicates no blanking when the RSRP is below a threshold RSRP to avoid unnecessary PRB blanking.

In yet other embodiments, a system is provided for detecting and mitigating interference of a satellite signal by one or more cell signals. The system comprises one or more processors and a non-transitory computer-readable storage medium coupled to the processors, storing programming instructions for execution by the processors to perform operations similar to those described in the method. The system includes receiving cell information from pods in an exclusion zone, monitoring the interference level and the RSRP, determining a PRB blanking level, and blanking a PRB of the PCI per the PRB blanking level.

In accordance with additional embodiments, the system includes receiving feeds from the pods, where each feed comprises current cell information detected by one of the pods. The exclusion zone may be created for a NOAA earth station for an exclusion time period. The system includes decoding the cell signal to obtain the cell information.

In further embodiments, the system involves associating, based on a location of a respective pod detecting the cell signal, a threshold RSRP and a threshold interference level for a respective PCI in the cell information. The threshold RSRP is compared to the RSRP of the respective PCI, and the threshold interference level is compared to the interference level of the respective PCI.

In yet other embodiments, the system involves associating, based on a location of a satellite communicating via the satellite signal, a threshold RSRP and a threshold interference level for a respective PCI in the cell information. The threshold RSRP is compared to the RSRP of the respective PCI, and the threshold interference level is compared to the interference level of the respective PCI.

In accordance with additional embodiments, the system includes inferring with an AI/ML module, based on a location of a satellite communicating via the satellite signal, a threshold RSRP and a threshold interference level for a respective PCI in the cell information. The threshold RSRP is compared to the RSRP of the respective PCI, and the threshold interference level is compared to the interference level of the respective PCI.

In further embodiments, the system includes recording, post-processing, and updating the AI/ML module using adaptive algorithms and decision-making models. The AI/ML module is trained to infer the threshold RSRP and the threshold interference level using a dataset, which includes records of a location from which the satellite signal is transmitted, a location of a pod in an exclusion zone, and cell information for the cell signal at the location.

In accordance with other embodiments, the PRB blanking level indicates no blanking when the RSRP is below a threshold RSRP to avoid unnecessary PRB blanking.

Additional features will be set forth in the description that follows, and in part will be apparent from the description, or may be learned by practice of what is described.

### DRAWINGS

In order to describe the manner in which the above-recited and other advantages and features may be obtained, a more particular description is provided below and will be rendered by reference to specific embodiments thereof which are illustrated in the appended drawings. Understanding that these drawings depict only typical embodiments and are not, therefore, to be limiting of its scope, implementations will be described and explained with additional specificity and detail with the accompanying drawings.

FIG. 1A illustrates a system including a satellite signal sharing a frequency spectrum with a cell signal proximate or around a satellite ground station disposed in an exclusion zone, according to various embodiments.

FIG. 1B is a closer look at an exclusion zone of the system of FIG. 1A, according to various embodiments.

FIG. 2 is a flowchart of an example method for detecting and mitigating interference of a satellite signal by one or more cell signals, according to various embodiments.

FIG. 3 illustrates a block diagram of a 5G cellular network systems according to various embodiments.

FIG. 4 is an exemplary functional framework for an AI/ML model according to various embodiments.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The present teachings may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as SMALLTALK, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Reference in the specification to “one embodiment” or “an embodiment” of the present invention, as well as other variations thereof, means that a feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

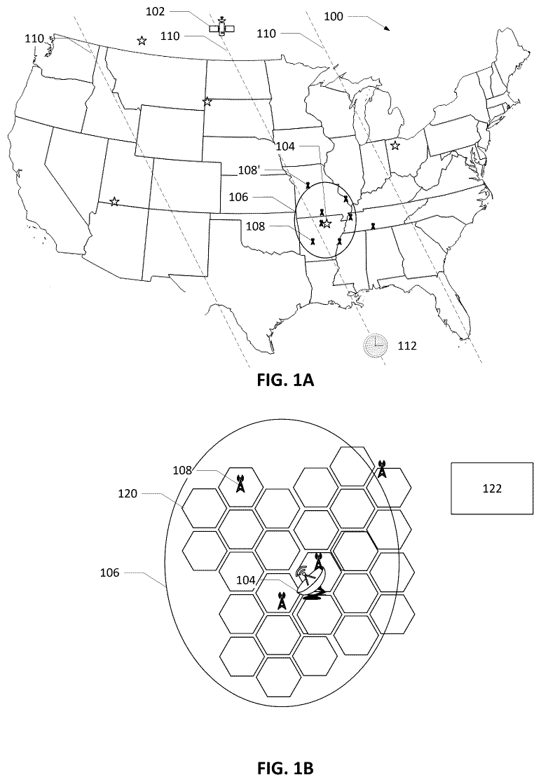

FIG. 1A illustrates a system including a satellite signal sharing a frequency spectrum with a cell signal proximate or around a satellite ground station disposed in an exclusion zone, according to various embodiments.

FIG. 1B is a closer look at an exclusion zone of the system of FIG. 1A, according to various embodiments.

Interference for a shared frequency spectrum (for example, the n70 band), between Terrestrial and Satellite Radio Networks (RANs), needs to be mitigated in a system 100. Data provided from a satellite user (for example, National Oceanic and Atmospheric Administration (NOAA)) lists exclusion zones and exclusion time periods. An exclusion zone 106 may define an earth surface area around satellite ground station 104. Exclusion zone 106 for satellite ground station 104 may encompass a large area around the ground station. In exclusion zone 106, transmissions in the shared spectrum by the cell network may be restricted, limited, or controlled to minimize interference with a satellite signal. Exclusion zone 106 may be static or dynamic. The exclusion zone 106 may include sectors or cells 120 of a cellular network proximate to and/or surrounding a satellite ground station 104.

The exclusion zone 106 may be variable as a Line-of-Sight (LOS) between a satellite 102 and satellite ground station 104. The variability in the exclusion zone may be caused by relative movement of a satellite to the ground surface, an orbit 110 of the satellite, the direction of orbit 110, ground topography or the like. Similarly, the exclusion time period 112 may be variable as the LOS varies between the ground station and the satellite. In some embodiments, the satellite may be geostationary earth orbit satellite and there may not be a limit on the exclusion time period. In some embodiments, the exclusion zone and/or time may be defined for other reasons.

An exclusion time period 112 may be periodic (for example, 14 days cycle) or aperiodic. Exclusion time period 112 may be static or dynamic.

Transmitters using the shared spectrum in the cell network may be user terminals, base stations, or both. The exclusion zone 106 and exclusion time period 112 may be used by a terrestrial user (for example, a cellular network provider) to forego use of the shared spectrum in the exclusion zone 106 during the exclusion time period 112. The cellular network provider may blank the use of the shared frequency spectrum in cells within the exclusion zone during the exclusion times.

The interference is mitigated or eliminated using full or partial PRB blanking based on detection using corrective actions. In some embodiments, the corrective actions may be recommended by an AI/ML model 122. The AI/ML model 122 receives detected cell information from a pod 108, monitors the interference within the exclusion zone 106 and recommends the PRB blanking of sectors that are causing interference. The recommended blanking may be implemented by a respective base station (not shown) of cells 120 within exclusion zone 106. Cells 120 subject to the blanking may be wholly or partially overlap a portion of the exclusion zone 106.

Pods 108 to detect cell signals using the shared spectrum may be deployed in exclusion zone 106. An outlier pod 108′ may or may not be in a given exclusion zone. In some embodiments, pods 108 may be more densely deployed in cells 120 that are closer to satellite ground station 104. A close cell may provide coverage to the satellite ground station 104. In some embodiments, a close cell may border the satellite ground station 104 cell. Pods 108 may send cell information to AI/ML model 122. Pods 108 may decode the cell signal to extract cell information such as the cell signal PCI, SINR, RSRP, and other signal quality information and metrics. In some embodiments, pods 108 may send excerpts of the cell signal to AI/ML model 122, and AI/ML model 122 may decode the excerpt to obtain the cell information.

There may be multiple ground stations and a corresponding number of exclusion zones. In some embodiments, distinct AI/ML models may be used for each of the multiple ground stations. Conversely, a single AI/ML model may handle one or more of the multiple ground stations. The AI/ML model may be implemented at a cellular network core or a regional data center.

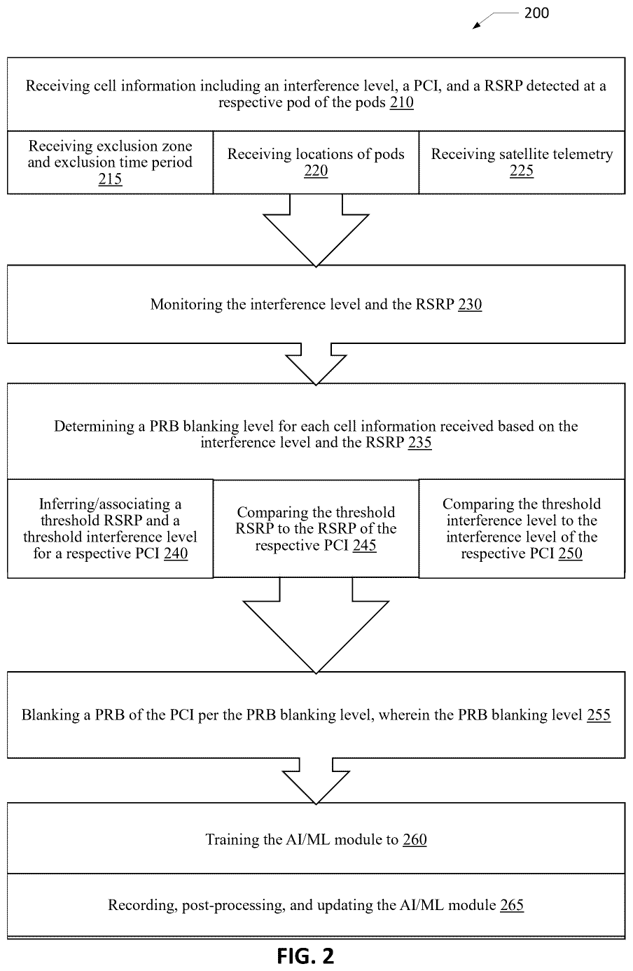

FIG. 2 is a flowchart of an example method for detecting and mitigating interference of a satellite signal by one or more cell signals, according to various embodiments.

A method 200 for detecting and mitigating interference of a satellite signal by one or more cell signals is provided. At a high level, method 200 disposes pod receivers (pods) around a satellite ground station to detect interference data, decode/post-process the interference data for cell information including the PCI, the RSRP and SINR values of the cell, receive the cell information at an AI/ML module to monitor the interference, and blank an interfering cell per a blanking level corresponding to the RSRP and/or interference level of the cell signal. The AI/ML model may record, post-process and update the machine learning model that determines a blanking level of the cell on. If the received signal strength is above the threshold, the cell may be turned off; if it is below the recommended signal strength, the cell may not be turned off. Method 200 may help calculate the interference at the exclusion zone and recommend the PRB blanking sectors impacted, thereby removing the dependency on NOAA, and only blanking those sectors that are causing interference. Advantages of method 200 include, for example, not turning off the cell signal when low traffic on the cellular network does not create interference sufficient to impact the robustness of the satellite signal reception.

Method 200 may include operation 210 for receiving cell information from pods disposed in an exclusion zone, the cell information comprising an interference level experienced by a cell signal sharing a frequency spectrum with a satellite signal, a Physical Cell Identity (PCI) of the cell signal, and a Reference Signal Receive Power (RSRP) of the cell signal at a respective pod of the pods.

Operation 210 may include operation 215 to receive an exclusion zone and exclusion time period, for example, from NOAA. Operation 210 may include operation 220 for receiving locations of pods. Operation 210 may include operation 225 for receiving satellite telemetry, for example, from NOAA.

Method 200 may include operation 230 for monitoring the interference level and the RSRP. In the context of operation 230 for monitoring the interference level and the Reference Signal Receive Power (RSRP), method 200 may involve the assessment of signal quality and the detection of interference. The interference level and the RSRP may be monitored to evaluate the signal strength and quality metrics. This monitoring may be facilitated by the deployment of pod receivers within an exclusion zone, which may continuously gather and send data on the interference level and RSRP as feeds. The feeds may be received at an AI/ML module that may calculate the interference and determine the signal strength and Signal-to-Interference-plus-Noise Ratio (SINR) values. The AI/ML module may make decisions regarding cell activity, such as turning off a cell if the signal strength exceeds a certain threshold. The AI/ML module may infer threshold values for RSRP and interference levels, which may be used to compare with actual values to detect interference.

Method 200 may include operation 235 for determining a Physical Resource Block (PRB) blanking level for each cell information received based on the interference level and the RSRP. A Physical Resource Block (PRB) blanking level may be determined for each cell information received. Initially, the Reference Signal Receive Power (RSRP) and the interference level may be associated with a threshold for a respective Physical Cell Identity (PCI) based on the location of a respective pod detecting the cell signal. This association may be for understanding the interference dynamics and the signal quality metrics. Furthermore, the location of a satellite communicating via the satellite signal may also be considered to associate a threshold RSRP and interference level for the PCI, which may provide a view of the interference landscape.

Method 200 may include operation 240 for inferring with an Artificial Intelligence/Machine Learning (AI/ML) module, based on a location of a satellite communicating via the satellite signal, a threshold RSRP and a threshold interference level for a respective PCI in the cell information.

Method 200 may include operation 245 for comparing the threshold RSRP to the RSRP of the respective PCI.

Method 200 may include operation 250 for comparing the threshold interference level to the interference level of the respective PCI.

Method 200 may include operation 255 for blanking a PRB of the PCI per the PRB blanking level, wherein the PRB blanking level indicates at least one of a complete blanking, a partial blanking, or no blanking. Operation 255 may be used for controlling signal interference by potentially mitigating the interference experienced by a satellite signal due to overlapping cell signals. The PRB blanking level may be determined based on the interference level and the Reference Signal Receive Power (RSRP) of the cell signal. The system may utilize an AI/ML processing module to calculate the interference and recommend the PRB blanking sectors impacted.

PRB blanking may be performed by scheduling signal blanking for user equipment (UE) within a cell based on the PCI causing satellite interference. For example, the 5G Next Generation Node B (gNB) supports orchestrating the timing and allocation of Physical Resource Blocks (PRBs) for UEs across a spectrum. For at least a portion of the exclusion time period, a gNB may be directed by the AI/ML module to not use the spectrum shared with the satellite to service user equipment within a cell. The gNB may utilize a restriction rule associated with the PCI and shared spectrum to determine which spectrum is temporarily disabled to reduce interference with satellite communications. This process may be conducted in anticipation of the satellite's presence in a specific location, as determined by the AI/ML module.

Method 200 may include operation 260 for recording, post-processing, and updating the AI/ML module comprises utilizing adaptive algorithms and decision-making models. Operation 210

Method 200 may include operation 265 for training the AI/ML module to infer the threshold RSRP and the threshold interference level using a dataset, wherein the dataset comprises records comprising a location that the satellite signal is being transmitted from, a location of a pod in an exclusion zone, and cell information for the cell signal at the location.

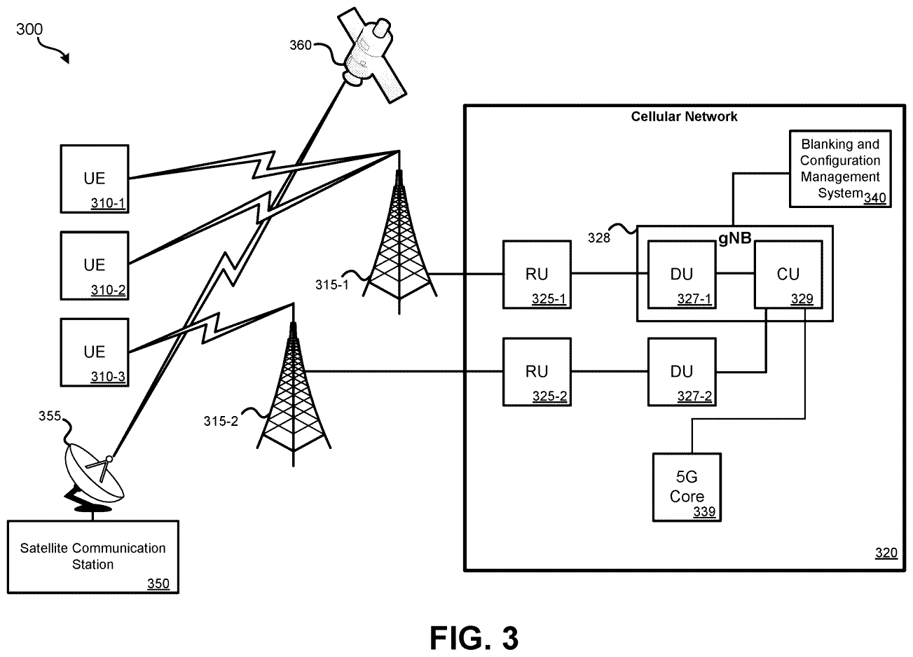

FIG. 3 illustrates a block diagram of an embodiment of a 5G cellular network system (“system 300”). System 300 can include a 5G New Radio (NR) cellular network or other types of cellular networks that permit slicing are also possible (e.g., future 6G and beyond cellular networks). System 300 can include: UE 310 (UE 310-1, UE 310-2, UE 310-3); base station 315; cellular network 320; radio units 325 (“RUs 325”); distributed units 327 (“DUs 327”); centralized unit 329 (“CU 329”); 5G core 339, and blanking and configuration management system 340 (“system 340”). FIG. 3 represents a component level view. In an open radio access network (O-RAN) using virtualization, components can be implemented as software, such as on a cloud-computing platform, except for components that need to receive and transmit RF. Therefore, the functionality of the various components can be shifted among different servers and/or data centers to accommodate where the functionality of such components is needed and/or where processing, storage, and/or bandwidth is available.

UE 310 can represent various types of end-user devices, such as smartphones, cellular modems, cellular-enabled computerized devices, sensor devices, gaming devices, access points (APs), any computerized device capable of communicating via a cellular network, etc. UE 310 may use RF to communicate with various BSs of cellular network 320. As illustrated, two base stations 315 (BS 315-1, 315-2) are illustrated. Real-world implementations of system 300 can include many (e.g., thousands) of base stations, RUs, DUs, and CUs. BS 315 can include one or more antennas that allow RUs 325 to communicate wirelessly with UE 310. RUs 325 can represent an edge of cellular network 320 where data is transitioned to wireless communication. The radio access technology (RAT) used by RU 325 may be 5G New Radio (NR), or some other RAT. The remainder of cellular network 320 may be based on an exclusive 5G architecture, a hybrid 4G/5G architecture, a 4G architecture, or some other cellular network architecture. Base station equipment may include an RU (e.g., RU 325-1) and a DU (e.g., DU 327-1). An RU and a DU can be co-located at a BS or a DU can be remote from the BS.

One or more RUs, such as RU 325-1, may communicate with DU 327-1. As an example, at a possible cell site, three RUs may be present, each connected with the same DU. Different RUs may be present for different portions of the spectrum. For instance, a first RU may operate on the spectrum in the citizens broadcast radio service (CBRS) band while a second RU may operate on a separate portion of spectrum, such as, for example, band n71. One or more DUs, such as DU 327-1, may communicate with CU 329. Collectively, RUs, DUs, and CUs serve as the radio access network (RAN) of cellular network 320. CU 329 can communicate with 5G core 339. The specific architecture of cellular network 320 can vary by embodiment.

Multiple slices may function on the underlying hardware detailed in FIG. 3. That is, UE 310-1 and UE 310-2, while communicating with the same base station, may be provided with different QoS/QoE levels of service by virtue of being assigned to different slices. Each slice may be associated with differing performance characteristics. For each slice, many characteristics or parameters may be defined, such as: downlink/uplink throughput (aggregate for network slice); downlink/uplink throughput (per UE); maximum downlink/uplink throughput; maximum supported packet size; mission critical level (e.g., compared to other network slices); radio spectrum; packet error rate; supported access technologies; supported device velocity for a defined QoS; uplink throughput (aggregate for network slice); maximum uplink throughput; and/or synchronicity. Other parameters for a slice may also be defined, such as: a defined latency range for specific end-points; reserved or shared spectrum; one or more particular security profiles; optimization for specific applications or sets of applications (e.g., healthcare applications, industrial applications); optimization for high-speed mobility; and varying degrees of customer-side control of network parameters. Other parameters may also be defined, such as parameters for individual layers within each network slice. Such individual layers may allow for particular types of data or data associated with particular applications to be prioritized over other applications.

Blanking and configuration management system 340 may be one or more computer servers or a process that hosted on a cloud-based computing platform. System 340 may be in communication with components of cellular network 320, such as directly with a DU or CU of a gNodeB (e.g., gNB 328) at which blanking needs to be performed. At a high level, blanking and configuration management system 340 schedules PRB blanking for individual BSs to accommodate reserved frequency bands being used by one or more primary entities. In some embodiments, rather than having a centralized blanking and configuration management system 340, system 340 may be incorporated as part of or in communication with each gNB of the cellular network that needs to occasionally avoid a primary entity's frequency band(s).

Functioning independently of the cellular network can be satellite ground communication station 350, satellite antenna 355, and satellite 360. Satellite ground communication station 350 communicates with satellite 360 via satellite antenna 355 on one or more particular frequency bands. If UE 310 and/or BSs 315 are operating on the same or overlapping subcarriers, interference can result in satellite ground communication station 350 and satellite 360 being unable to communicate or can result in decreased quality of service. Satellite 360 may be in LEO or MEO and communication between satellite ground communication station 350 and satellite 360 may only occur when the orbit of satellite 360 allows for a line of sight communication link between satellite antenna 355 and an antenna of satellite 360. Satellite ground communication station 350 may also periodically or occasionally communicate with one or more other satellites, possibly using the same or different frequency bands. In the embodiments detailed herein, the operator of satellite ground communication station 350 and satellite 360 is the primary user of the one or more particular frequency bands. Accordingly, the cellular network operator is required to not interfere with the operations of the satellite operator.

Cellular networks include Radio Access Networks (RANs) and a network core. RANs belonging to 4G are known as Long Term Evolution (LTE) and RANs belonging to 5G are known as New Radio (NR), which has been standardized to allow tight interworking with LTE. The RAN includes antennae seen on cellular telecommunications towers and other locations (e.g., on top of buildings, in stadiums, etc.). When a cellular telephone call is made via a mobile device or a Short Message Service (SMS) message is sent, for example, antenna(s) of the RAN transmit signals to and receive signals from the mobile device. The RAN base station also digitizes the signals from the mobile device and sends this information to the network core.

In an Open RAN (O-RAN) architecture, the RAN includes three main building blocks: the Radio Unit (RU), the Distributed Unit (DU), and the Centralized Unit (CU). The RUs transmit, receive, amplify, and digitize radio frequency signals. RUs are located near, or integrated into, an antenna of the cellular telecommunications tower, and are operably connected to the antenna. Each cellular telecommunications tower may have multiple RUs to fully service various bands for a particular coverage area. The DU receives the digitized radio signals from the RU(s) via a Cellular Site Router (CSR) that routes traffic from the RUs to the DU and sends the digitized radio signal to the CU for further processing. The DU is usually physically located at or near the RU, whereas the CU can be located nearer to the network core (e.g., in a Pass-through Edge Data Center (PEDC) or a Breakout Edge Data Center (BEDC)).

The key concept of O-RAN is “opening” the protocols and interfaces between the various building blocks (i.e., radios, hardware, and software) in the RAN. The O-RAN Alliance has defined various interfaces within the RAN, including those for fronthaul between the RU and the DU, midhaul between the DU and the CU, and backhaul connecting the RAN to the network core. The CU accommodates the higher protocol stack layers while the DU accommodates the lower protocol stack layers.

DUs are the main processing units that are responsible for the High Physical, Media Access Control (MAC), and Radio Link Control (RLC) protocols in the RAN protocol stack under the Third Generation Partnership Project (3GPP). In other words, DUs are a logical encapsulation of the 3GPP stack. In O-RAN or virtualized RAN (vRAN), DUs typically run the real time RAN functions located below split 2 and connect with the RUs through a fronthaul interface based on O-RAN split 7-2x. DUs perform Layer 1(L1 ) and Layer 2 (L2) processing.

Kubernetes® may be used for DUs to provide a portable, extensible, open source platform for managing containerized workloads and services that facilitates both declarative configuration and automation. Containers are similar to Virtual Machines (VMs). However, they have relaxed isolation properties to share the Operating System (OS) among the applications. Therefore, containers are considered lightweight. Similar to a VM, a container has its own file system, a share of Central Processing Unit (CPU) resources, memory, process space, etc. Since containers are decoupled from the underlying infrastructure, they are portable across clouds and OS distributions. DUs may be responsible for performing PRB blanking.

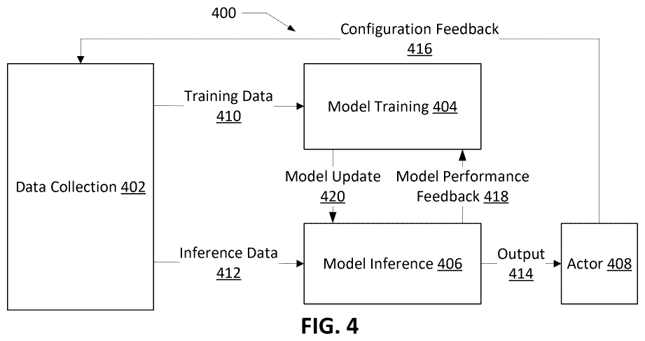

FIG. 4 is an exemplary functional framework for an AI/ML model according to various embodiments.

A framework 400 for an AI/ML model may include a data collection module 402. Data collection module 402 provides input or training data 410 to a Model Training module 404 and a Model inference module 406. Examples of training data 410 include detected cell information from a pod 108. Training data 410 includes data needed as input for Model training module 404. Model training module 404 may include an AI/ML function. Data collection module 402 may provide inference data 412 as input for the Model inference module 406.

Model Training module 404 performs the AI/ML model training, validation, and testing. Model inference module 406 may generate model performance metrics or feedback 418 as part of the model testing procedure. Model deployment/update 420 may be used to initially deploy a trained, validated, and tested AI/ML function to the Model Inference module 406 or to deliver an updated model to the Model Inference module 406.

Model Inference module 406 provides an AI/ML model inference output. Model Inference module 406 may provide a Model Performance Feedback 418 to model training module 404 when applicable. Model performance feedback 418 may be for monitoring the performance of the AI/ML model, when available. Feedback 418 may be used to derive training data, inference data or to monitor the performance of the AI/ML Model and its impact to the network through updating of KPIs and performance counters. In some embodiments, model Inference module 406 may use an AI/ML function to produce an output 414. Output 414 may include PRB blanking recommendation for a PCI.

Actor 408 receives the output 414 from the Model Inference module 406 and triggers or performs corresponding actions, for example, PRB blanking to mitigate interference with a satellite signal.

Having described preferred embodiments of a system and method (which are intended to be illustrative and not limiting), it is noted that modifications and variations can be made by persons skilled in the art considering the above teachings. It is therefore to be understood that changes may be made in the embodiments disclosed which are within the scope of the invention as outlined by the appended claims. Having thus described aspects of the invention, with the details and particularity required by the patent laws, what is claimed and desired protected by Letters Patent is set forth in the appended claims.

We claim as our invention:

1. A method for detecting and mitigating interference of a satellite signal by one or more cell signals, comprising:
receiving cell information from pods disposed in an exclusion zone, the cell information comprising an interference level experienced by a cell signal sharing a frequency spectrum with a satellite signal, a Physical Cell Identity (PCI) of the cell signal, and a Reference Signal Receive Power (RSRP) of the cell signal at a respective pod of the pods;
monitoring the interference level and the RSRP;
determining a Physical Resource Block (PRB) blanking level for each cell information received based on the interference level and the RSRP; and
blanking a PRB of the PCI per the PRB blanking level, wherein the PRB blanking level indicates at least one of a complete blanking, a partial blanking, or no blanking.

2. The method of claim 1, wherein the receiving comprises receiving feeds from the pods, wherein each of the feeds comprises current cell information detected by one of the pods.

3. The method of claim 1, wherein the exclusion zone is created for a National Oceanic and Atmospheric Administration (NOAA) earth station.

4. The method of claim 1, wherein the receiving comprises decoding the cell signal to obtain the cell information.

5. The method of claim 1, wherein the determining comprises
associating, based on a location of a respective pod of the pods detecting the cell signal, a threshold RSRP and a threshold interference level for a respective PCI in the cell information,
comparing the threshold RSRP to the RSRP of the respective PCI, and
comparing the threshold interference level to the interference level of the respective PCI.

6. The method of claim 1, wherein the determining comprises
associating, based on a location of a satellite communicating via the satellite signal, a threshold RSRP and a threshold interference level for a respective PCI in the cell information,
comparing the threshold RSRP to the RSRP of the respective PCI, and
comparing the threshold interference level to the interference level of the respective PCI.

7. The method of claim 1, wherein the determining comprises
inferring with an Artificial Intelligence/Machine Learning (AI/ML) module, based on a location of a satellite communicating via the satellite signal, a threshold RSRP and a threshold interference level for a respective PCI in the cell information,
comparing the threshold RSRP to the RSRP of the respective PCI, and
comparing the threshold interference level to the interference level of the respective PCI.

8. The method of claim 7, further comprising recording, post-processing, and updating the AI/ML module comprises utilizing adaptive algorithms and decision-making models.

9. The method of claim 7, further comprising training the AI/ML module to infer the threshold RSRP and the threshold interference level using a dataset, wherein the dataset comprises records comprising a location that the satellite signal is being transmitted from, a location of a pod in an exclusion zone, and cell information for the cell signal at the location.

10. The method of claim 1, wherein the PRB blanking level indicates the no blanking when the RSRP is below a threshold RSRP to avoid unnecessary PRB blanking.

11. A system to detect and mitigate interference of a satellite signal by one or more cell signals, comprising:
one or more processors; and
a non-transitory computer-readable storage medium coupled to the one or more processors and storing programming instructions for execution by the one or more processors, the programming instructions instructing the one or more processors to perform operations comprising:
receiving cell information from pods disposed in an exclusion zone, the cell information comprising an interference level experienced by a cell signal sharing a frequency spectrum with a satellite signal, a Physical Cell Identity (PCI) of the cell signal, and a Reference Signal Receive Power (RSRP) of the cell signal at a respective pod of the pods;
monitoring the interference level and the RSRP;
determining a Physical Resource Block (PRB) blanking level for each cell information received based on the interference level and the RSRP; and
blanking a PRB of the PCI per the PRB blanking level, wherein the PRB blanking level indicates at least one of a complete blanking, a partial blanking, or no blanking.

12. The system of claim 11, wherein the receiving comprises receiving feeds from the pods, wherein each of the feeds comprises current cell information detected by one of the pods.

13. The system of claim 11, wherein the exclusion zone is created for a National Oceanic and Atmospheric Administration (NOAA) earth station for an exclusion time period.

14. The method of claim 1, wherein the receiving comprises decoding the cell signal to obtain the cell information.

15. The system of claim 11, wherein the determining comprises
associating, based on a location of a respective pod of the pods detecting the cell signal, a threshold RSRP and a threshold interference level for a respective PCI in the cell information,
comparing the threshold RSRP to the RSRP of the respective PCI, and
comparing the threshold interference level to the interference level of the respective PCI.

16. The system of claim 11, wherein the determining comprises
associating, based on a location of a satellite communicating via the satellite signal, a threshold RSRP and a threshold interference level for a respective PCI in the cell information,
comparing the threshold RSRP to the RSRP of the respective PCI, and
comparing the threshold interference level to the interference level of the respective PCI.

17. The system of claim 11, wherein the determining comprises
inferring with an Artificial Intelligence/Machine Learning (AI/ML) module, based on a location of a satellite communicating via the satellite signal, a threshold RSRP and a threshold interference level for a respective PCI in the cell information,
comparing the threshold RSRP to the RSRP of the respective PCI, and
comparing the threshold interference level to the interference level of the respective PCI.

18. The system of claim 17, further comprising recording, post-processing, and updating the AI/ML module comprises utilizing adaptive algorithms and decision-making models.

19. The system of claim 17, further comprising training the AI/ML module to infer the threshold RSRP and the threshold interference level using a dataset, wherein the dataset comprises records comprising a location that the satellite signal is being transmitted from, a location of a pod in an exclusion zone, and cell information for the cell signal at the location.

20. The system of claim 11, wherein the PRB blanking level indicates the no blanking when the RSRP is below a threshold RSRP to avoid unnecessary PRB blanking.
